(19) United States
(12) Patent Application Publication
(10) Pub. No.: US 2023/0054925 A1
(43) Pub. Date: Feb. 23, 2023

(54) OVERCOMING UNRESPONSIVE BEHAVIOR FROM AERIAL USER EQUIPMENT

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); David Ross Beppler, Duluth, GA (US); Slawomir Stawiarski, Carpentersville, IL (US)

(21) Appl. No.: 17/406,731

(22) Filed: Aug. 19, 2021

(51) Int. Cl. H04W 76/19; H04W 76/38; H04W 76/28

(52) U.S. Cl. CPC H04W 76/19; H04W 76/38; H04W 76/28

(57) ABSTRACT

An architecture to eliminate situations in which aerial user equipment become unreachable by core mobile network operator equipment as a consequence of radio link failure events. A method comprises determining, based on type data, that a user equipment is an aerial user equipment, initiating a discontinuous reception timer device using defined time values, transmitting downlink data addressed to the aerial user equipment, determining, based on an expiration of the defined time values as measured by the discontinuous reception timer device and acknowledgement data associated with the transmitting of the downlink data, that the aerial user equipment is unreachable, and based on the aerial user equipment being unreachable, sending request data to base station equipment, wherein the request data facilitates the base station equipment to terminate a communication channel that links the base station equipment to the aerial user equipment.

### TECHNICAL FIELD

The disclosed subject matter relates to reducing or eliminating situations in which aerial user equipment become unreachable by core mobile network operator (MNO) equipment as a consequence of radio link failure (RLF) events.

### BACKGROUND

Wireless operators can use terrestrial cellular network equipment, such as long-term evolution (LTE) and/or fifth-generation (5G) core mobile network operator (MNO) equipment to provide services to aerial UE. Generally, unmanned aerial vehicles (UAVs) or aerial user equipment (UE) can require beyond visual line-of-sight (LOS) communications. MNO entity network infrastructures can offer wide area, high-speed, and secure wireless connectivity, which can enhance control and safety of aerial UE operations, and can enable beyond visual LOS capabilities. For instance, current LTE core networks can support initial aerial drone (e.g., aerial UE) deployments. It is envisaged the evolution of LTE into the arena of fifth-generation (5G) technologies will provide more efficient connectivity for wide-scale drone deployments. Additionally, new and exciting opportunities and applications for aerial UE are emerging. These new and exciting applications can be potential business areas for MNO entities. Furthermore, the use cases for commercial aerial UE are growing rapidly, including use in delivery of goods, communications, media, inspection of critical infrastructure, surveillance, search-and-rescue operations, agriculture, and similar endeavors.

### BRIEF DESCRIPTION OF DRAWINGS

FIG. 1 is an illustration of a system that reduces or eliminates situations in which aerial user equipment become unreachable by core mobile network operator (MNO) equipment as a consequence of radio link failure (RLF) events, in accordance with aspects of the subject disclosure.

FIG. 2 provides illustration of an additional system that reduces or eliminates situations in which aerial user equipment become unreachable by core MNO equipment as a consequence of RLF events, in accordance with aspects of the subject disclosure.

FIG. 3 provides illustration of a further system that reduces or eliminates situations in which aerial user equipment become unreachable by core MNO equipment as a consequence of RLF events, in accordance with aspects of the subject disclosure.

FIG. 4 provides illustration of a time sequence chart or method for reducing or eliminating situations in which aerial user equipment become unreachable by core MNO equipment as a consequence of RLF events, in accordance with aspects of the subject disclosure.

FIG. 5 provides illustration of a flow chart or method for reducing or eliminating situations in which aerial user equipment become unreachable by core MNO equipment as a consequence of RLF events, in accordance with aspects of the subject disclosure.

FIG. 6 provides illustration of another flow chart or method for reducing or eliminating situations in which aerial user equipment become unreachable by core MNO equipment as a consequence of RLF events, in accordance with aspects of the subject disclosure.

FIG. 7 provides illustration of an additional flow chart or method for reducing or eliminating situations in which aerial user equipment become unreachable by core MNO equipment as a consequence of RLF events, in accordance with aspects of the subject disclosure.

FIG. 8 depicts another time sequence chart or method for reducing or eliminating situations in which aerial user equipment become unreachable by core MNO equipment as a consequence of RLF events, in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed example embodiments.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

The disclosed subject matter, in accordance with various embodiments, provides a system, apparatus, equipment, or device comprising: a processor, and a memory that stores executable instructions that, when executed by the processor, facilitate performance of operations. The operations can comprise receiving, from a user equipment, type data, determining, based on the type data, that the user equipment is an aerial user equipment, initiating a discontinuous reception timer clock using defined time values, transmitting downlink data addressed to the aerial user equipment, determining, based on an expiration of the defined time values as measured by the discontinuous reception timer clock and acknowledgement data associated with the transmitting of the downlink data, that the aerial user equipment is unreachable; and based on the aerial user equipment being unreachable, sending request data to serving equipment, wherein the request data facilitates the serving equipment to release a radio bearer that communicatively links the network equipment to the aerial user equipment.

In regard to the foregoing the type data can be bit data representing a sequence of bits and/or the type data can be representative of international mobile subscriber identification data. Further, the defined time values can be first defined time values, and the first defined time values can be greater than second defined time values that can be associated with terrestrial based user equipment.

Additional operations can include in response to transmitting the downlink data, monitoring the transmitting of the downlink data to the aerial user equipment, and determining, based on the transmitting of the downlink data, that the aerial user equipment has failed to return the acknowledgement data.

In accordance with further embodiments, the subject disclosure describes methods and/or processes, comprising a series of acts that, for example, can include: receiving release radio bearer data from network equipment, based on the release radio bearer data, terminating a communications link established between the serving equipment and an aerial user equipment, based on the release radio bearer data, determining that the aerial user equipment has transitioned from a first state to a second state, receiving downlink data addressed to the aerial user equipment, and based on receiving the downlink data, transmitting wake up data to the aerial user equipment.

In the context of the foregoing, the wake up data can facilitate the aerial user equipment to re-establish the communications link to the serving equipment, the first state is a connected state, the second state is an idle state, and the wake up data can facilitate the aerial user equipment to transition from the second state to the first state.

Additional acts can include in response to determining that the aerial user equipment has entered the second state, storing the downlink data addressed to the aerial user equipment, and based on the aerial user equipment being in the first state, transmitting the downlink data addressed to the aerial user equipment.

In accordance with still further embodiments, the subject disclosure describes machine readable media, computer readable storage devices, or non-transitory machine readable media comprising instructions that, in response to execution, cause a computing system (e.g., equipment, devices, groupings of devices, etc.) comprising at least one processor to perform operations. The operations can include: determining, based on type data, that a user equipment is an aerial user equipment, initiating a discontinuous reception timer device using defined time values, transmitting downlink data addressed to the aerial user equipment, determining, based on an expiration of the defined time values as measured by the discontinuous reception timer device and acknowledgement data associated with the transmitting of the downlink data, that the aerial user equipment is unreachable, and based on the aerial user equipment being unreachable, sending request data to base station equipment, wherein the request data facilitates the base station equipment to terminate a communication channel that links the base station equipment to the aerial user equipment.

The subject disclosure, in example embodiments, describes reducing or eliminating situations in which aerial UE become unreachable by core MNO equipment as a consequence of RLF events. As has been observed earlier, wireless MNOs can use terrestrial cellular networks (e.g., LTE, 5G, and similar networking technologies) to provide services to aerial UE. Wireless MNOs can use larger discontinuous reception (drx) inactivity timer values associated with aerial UE in comparison to drx inactivity timer values typically associated with terrestrial based UE, in order to minimize or eliminate transition delay when aerial UE wake up. Aerial UE can experience radio link failure (RLF) events when traversing a MNOs wireless core infrastructure. When UEs generally experience RLFs a timer (e.g., T311) is typically initiated by UE. The T311 timer is generally configured by core equipment when UE and core equipment initially effectuate attachment with one another. During the running of the T311 timer UE generally will attempt to reconnect to core equipment (e.g., proximate serving cell equipment, such as base station equipment, access point equipment, and similar core network equipment). In instances where UE are unable to identify and find core equipment signal pilot signals prior to the expiration of the timer (e.g., the T311 timer) UE, upon expiration of the T311 timer, transitions from a first state (e.g., connected state) to a second state (e.g., idle state). Once UE has entered into the second state and should UE subsequently identify suitable core equipment pilot signals emanating from core equipment, UE can camp onto the core equipment in the second state (e.g., idle state). Although the UE can be aware that a RLF event has occurred, core equipment can nevertheless be unaware of the loss of connection with the UE until a drx inactivity timer has expired. Thus, since core equipment can be unaware that the connection to the UE has been lost, core equipment will continue to maintain the radio bearer with UE until the timer (e.g., drx inactivity timer) expires despite the fact that connection to the UE has been lost. At this juncture, the UE is operating in an idle state (e.g., radio resource control (RRC) idle state) and core equipment is operating in the belief that the UE is operating in a connected state (e.g., RRC connected state). This discrepancy can make the UE unreachable by core equipment (e.g., proximate serving cell equipment—a grouping of core equipment devices in the general vicinity of the UE). Consequently, when the UE is unreachable by core equipment, any downlink data (DL.data) that arrives for the UE, core equipment (e.g., proximate serving cell equipment) will attempt to forward the DL.data to the UE through the existing radio bearer. As will be appreciated by persons of ordinary skill, since the UE is not connected to this radio bearer the DL.data transmission(s) will fail and the DL.data will not reach the UE. Consequently, the UE is unreachable by core equipment. When the drx inactivity timer expires, the UE radio bearer will be released by core equipment, and at that point in time core equipment will become aware that the UE has entered an idle state (e.g., RRC idle state). Once the radio bearer from core equipment to the UE has been released and once the core equipment has become aware that the UE has entered an idle state, core equipment can transmit paging data to locate the UE, wherein the paging data, on receipt by the UE, can facilitate and/or effectuate determination of the location of the UE as well as wake up the UE—transition the UE from an idle state (e.g., RRC idle state) to a connected state (e.g., RRC connected state).

Aerial UE can experience a period of time during which it is unreachable by core equipment, during which time ground control equipment controlling the aerial UE will be unable to control the aerial UE and therefore control and navigation of the aerial UE can be compromised; in some instances critically.

The disclosed and described subject matter details reducing or eliminating situations in which aerial UE become unreachable by core equipment due to RLF events. The description sets forth processes that in execution identify whether or not a UE is an aerial UE or a terrestrial based UE. Generally, in some embodiments usage type data representing a bit, series of bits, a flag, or the like can be used to convey whether or not a UE is operating as a terrestrial based UE or operating as an aerial UE. In response to determining that a UE is operational as an aerial UE the processes, in some embodiments, can infer or determine that a discontinuous response (drx) inactivity timer value associated with aerial UE should be defined as a value that is greater than a value normally or typically set for a T311 value associated with terrestrial based UE. It should be noted that a T311 timer (and/or a drx inactivity timer) is generally a system clock (e.g., a generic system clock, count-up clock, count-down clock, a system clock specifically assigned the function of acting as a T311 clock (and/or a drx inactivity clock), and/or similar such configured clocks) that is started at the initiation of RRC connection reestablishment procedure. The described processes, based at least on an understanding that the UE at issue is an aerial UE and further that aerial UE can be unreachable after RLF events, can constantly monitor down link data (DL.data) sent to the aerial UE at issue. Should the aerial UE, in response to DL.data having been sent to it, not reply with corresponding acknowledgement data within a defined period of time, the disclosed processes can determine that the aerial UE at issue has become unreachable to core equipment and that the core equipment should release the radio bearer for the aerial UE.

In fourth generation (4G) and/or fifth generation (5G) technologies, power saving mechanisms can specify and/or define periods of time during which UE go into sleep mode and/or powers off its reception equipment in order to save power. While UE is in a connected state (e.g., RRC connected state), UE has to monitor the physical downlink control channel (PDCCH) channels periodically (e.g., every subframe) in order to check if there is downlink data available. The monitoring of PDCCH channels while UE are in a connected state in order to determine whether there is available downlink data can consume a lot of the UE's battery power.

The third generation partnership project (3GPP) specifications define a mechanism named discontinuous reception (drx) in order to save the energy consumption of UE operation, where a UE is allowed to stop monitoring PDCCH channels for defined periods of operation time. Core equipment (e.g., base station equipment, such as eNodeB equipment, gNodeB equipment, femto cell equipment, microcell equipment, macro cell equipment, picocell equipment, Internet of Things (IoT) equipment, and similarly configured equipment) generally can configure drx with a group of drx parameter values. These drx parameter values can be determined and/or selected in order to save or conserve UE battery power and maximize network resource savings. Core equipment, such as base station equipment, can transmit drx configuration values to UE using a drx-configuration structure under a defined structural configuration schema that configures drx settings (e.g., MAC-MainConfig).

The defined structural configuration schema used for drx settings can comprise drx inactivity timer values representing the number of consecutive PDCCH subframes for which the UE should be active after successfully decoding a PDCCH channel indicating a new uplink (UL) transmission or new downlink (DL) transmission. Generally, drx inactivity timer values (and associated drx inactivity timer clocks) can be reset on receiving PDCCH subframes for a new transmission (e.g., UL or DL). Upon expiry of the timer, the UE should transition or enter a drx-mode (e.g., a mode that facilitates and/or effectuates the preservation of the battery life of the UE).

Once UE enters the drx-mode the UE can monitor the PDCCH channel less frequently. Should no new UL transmission or DL transmission be detected while the UE is in the drx-mode for the time period defined by, or associated with, the drx inactivity timer values, the core equipment (e.g., base station equipment) can release the radio bearer associated with the UE, at which point the UE can transition from a first state (e.g., RRC-connect state) to a second state (e.g., RRC-idle state). When the UE has entered the second state (e.g., RRC-idle state) the UE can monitor the paging channel to detect incoming transmissions. If a transmission is detected for the UE at issue, the UE can wake up, transition from the second state (e.g., RRC-idle state) to the first state (e.g., RRC-connect state), and thereafter reconnect to core equipment (e.g., base station equipment) in the first state (e.g., RRC-connect state). Generally, the periodicity of checking for incoming transmission in the second state (e.g., RRC-idle state) can be much larger than in a drx-mode. Thus, power saving is achieve through the use of drx mechanisms.

Use of drx inactivity timers can optimize UE power and network (e.g., core equipment infrastructure) resources through the use of short timer values that can save resources since RRC connections are released more frequently that can provide maximum UE power savings. Shorter timer values can result in UE experiencing transition delays when the UE wakes up (e.g., transitioning between states (i.e., first states to second states, second states to first states, etc.)). On the other hand, longer timer values can waste resources on unnecessarily maintaining RRC connections, thereby minimizing UE power savings. Longer timer values however can result in the UE experiencing fewer transition delays.

As has been observed earlier, wireless operators can use terrestrial cellular network technologies (e.g., LTE, 5G, . . . ) to provide services to aerial UE. Aerial UE can be employed in multiple use case situations. Typically, control equipment located on the ground can control aerial UE. The control equipment can use information from aerial UE, such as video cameras, sensors, and/or other sources to decide aerial UE trajectory. Wireless MNO core equipment infrastructure can use larger drx inactivity timer values in the context of servicing aerial UE as compared to terrestrial based UE, in order to minimize or eliminate transition delays when UE move from an idle state (e.g., RRC idle state) to a connected state (e.g., RRC connected state). It should be noted in some embodiments set forth in this description that large aerial UE can have considerably larger batteries (with significantly more charge capacity) than terrestrial based UE.

As also observed above, aerial UE can experience RLF events while traversing a core network infrastructure maintained by a MNO and/or groupings of MNOs, since the terrestrial LTE/5G has been designed for terrestrial UE (e.g., base station equipment antennas are typically pointed down). In addition, large aerial UEs can experience banking (e.g., aerial UE wings blocking radio signal emitted from the ground) while aerial UE are turning.

In general, a first timer (e.g., a T311 timer) and a second timer (e.g., a drx inactivity timer) can be configured by core equipment, such as base station equipment, during attachment processes effectuated when UE and core equipment establish initial communication links between one another. When UE experience a RLF, a first timer (e.g., a T311 timer) can be initiated. During the running of the T311 timer UE can try to reconnect to core equipment, if UE cannot find any core equipment signal pilots before the timer T311 expires then UE can transit from a connect state (e.g., RRC connect state) to an idle state (e.g., RRC idle state). Although UE can be aware of the RLF event, core equipment may nevertheless not be aware of loss of connection with UE, and therefore core equipment, such as eNodeB (eNB) equipment and/or evolved packet core (ePC) equipment, can persist in maintaining the UE radio bearer up until the second timer (e.g., drx inactivity timer) expires. At this stage UE is in an idle state (e.g., RRC idle state) and core equipment believes this UE is in RRC-Connected stage. This discrepancy can make the UE unreachable by the network infrastructure. In other words, if DL.data arrives for this UE, the core equipment can attempt to send the DL.data to the UE through the existing radio bearer. However, since the UE is now no longer connected to the radio bearer the DL.data will not reach the UE. Consequently, the UE is unreachable by the network infrastructure. Only when the second timer (e.g., drx inactivity timer) expires will core equipment release the UE radio bearer and only then will the network infrastructure become aware that the UE has entered into an idle state (e.g., RRC idle state). Once the network infrastructure become fully aware of the fact that UE has entered into the idle state, core equipment can send a paging message to locate the UE and wake the UE before sending the DL.data to the UE. Alternatively, if UE receives UL.data, this UL.data can force UE to transition from an idle connected state (e.g., IDLE connected state) to a connected state (e.g., RRC connected state and therefore UE will send a re-establishment request (e.g., RRC.Connection.Reestablishment.Request) to core equipment (e.g., eNB equipment and/or ePC equipment. Core equipment can then respond to this message by releasing the existing radio bearer between the core equipment and the UE and facilitate the establishment of a new radio bearer between the UE and the core equipment. It is at this latter point in time that the core equipment comes to the full realization that the UE experienced an RLF event.

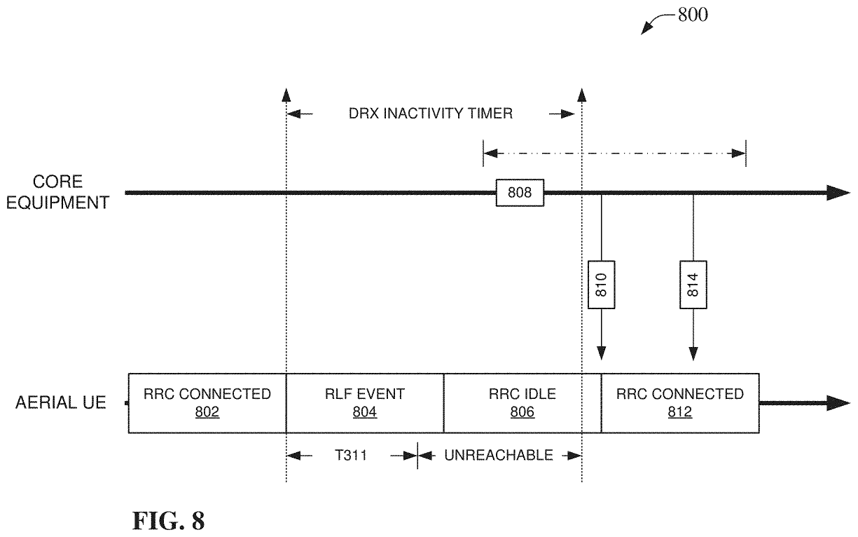

With regard to the foregoing, FIG. 8 presents an illustrative time sequence chart 800 that highlights the interaction that can occur between core equipment (e.g., proximate base station equipment) and aerial UE in accordance with various embodiments described herein. As depicted in time sequence chart 800 aerial UE can be in an connected state (e.g., RRC connected 802). At a point in time aerial UE can experience an RLF event (e.g., RLF 804), at which point a first timer (e.g., drx inactivity timer comprising values associated with a T311 time value and an additional time value used by core equipment to account for the fact that aerial UE can be unreachable for time periods that are of longer time durations than the typical T311 time values generally associated with terrestrial based UE) and a second timer (e.g., T311 timer) can be commenced. Typically, as noted above, the T311 values and the additional time values associated with the running of the drx inactivity timer can have been supplied by core equipment, such as base station equipment, during earlier attachment processes effectuated when the aerial UE and core equipment initially established communication links (e.g., established a radio bearer) between one another. During the RLF event (e.g., RLF 804), and prior to the expiration of the drx inactivity timer, aerial UE can attempt to re-establish connection with core equipment. If, during the RLF event after the expiration of the T311 timer but prior to the expiration of the drx inactivity timer, aerial UE is unable to find pilot signals emanating from and/or being emitted by core equipment, aerial UE in order to conserve aerial UE resources (e.g., battery power, . . . ), aerial UE can determine that it has become unreachable by core equipment and can transition from a connected state (e.g., RRC connected 801) to an idle state (e.g., RRC idle 806). At this time (e.g., when aerial UE transitions from the connected state (e.g., RRC connected 801) to the idle state (e.g., RRC idle 806)), core equipment, because the drx inactivity timer has yet to expire, will typically be unaware that aerial UE has entered into an idle state, and as a consequence core equipment, in the continued belief that the aerial UE is still in a connected state (e.g., RRC connected 801) will continue to maintain the radio bearer to the aerial UE. As has been noted earlier, this discrepancy can make the aerial UE unreachable by core equipment.

It is when, at act 808, the drx inactivity timer expires and/or core equipment receives downlink data (e.g., DL.data) addressed to aerial UE, and is subsequently unable to successfully forward and deliver the DL.data to the aerial UE (e.g., aerial UE fails to appropriately acknowledge receipt of the DL.data through a returned acknowledgment data) that core equipment becomes cognizant that aerial UE has become unreachable by core equipment. In response to becoming aware that the aerial UE is unreachable by core equipment, core equipment, at act 810, can send paging message data that can wake up aerial UE and facilitate and/or effectuate the aerial UE to transition from the idle state (e.g., RRC idle 806) to a connected state (e.g., RRC connected 812). Contemporaneously with, or shortly subsequent to, transmitting the paging message data, core equipment, at act 814, can send, to aerial UE, DL.data that was addressed to the aerial UE.

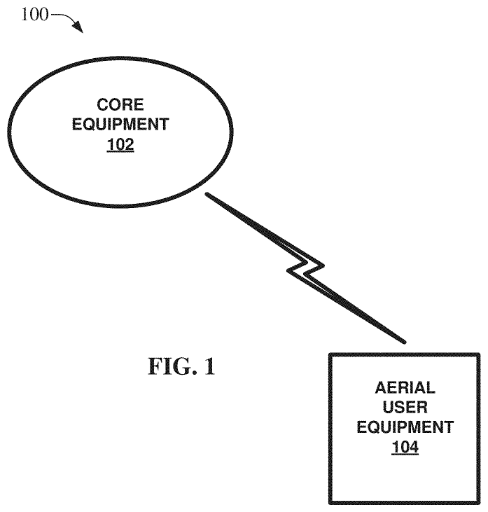

Turning now to FIG. 1 that illustrates a system 100 that reduces or eliminates situations in which aerial user equipment become unreachable by core mobile network operator (MNO) equipment as a consequence of radio link failure (RLF) events, in accordance with various embodiments. As depicted, system 100 comprises core equipment 102 and aerial UE 104 that can be in operative communication with one another. Core equipment 102 can form a grouping of core MNO equipment such as base station equipment, eNodeB equipment, eNB equipment, gNodeB equipment, picocell equipment, macrocell equipment, microcell equipment, femtocell equipment, internet of things (IoT) equipment operating as MNO network equipment, access point equipment, or other such equipment, and can provide services to aerial UE.

Aerial UE 104 can be any type of mechanism, machine, device, apparatus, equipment, and/or instrument that can achieve airborne flight and communication with core equipment. Examples of types of mechanisms, equipment, machines, devices, apparatuses, and/instruments can include virtual reality (VR) devices, wearable devices, heads up display (HUD) devices, machine type communication devices, and/or wireless devices that communicate with radio network nodes in a cellular or mobile communication system. In various other embodiments, aerial UE 104 can comprise tablet computing devices, handheld devices, server class computing machines and/or databases, laptop computers, notebook computers, desktop computers, cell phones, smart phones, commercial and/or consumer appliances and/or instrumentation, industrial devices and/or components, personal digital assistants, multimedia Internet enabled phones, internet enabled devices, multimedia players, aeronautical/avionic devices associated with, for example, orbiting satellites and/or associated aeronautical vehicles, and the like.

In accordance with various embodiments, core equipment 102 can be a central node global control device located on a MNO core network infrastructure. Examples of central node global control devices can comprise mobile edge compute (MEC) equipment, self organized network (SON) equipment, radio access network (RAN) intelligent controller (RIC) equipment, and/or similar equipment that can perform the functionalities and/or facilities described and/or disclosed herein. Core equipment 102 in some embodiments can receive UE data comprising UE type data from UE equipment. In response to receiving UE data core equipment 102 can determine whether the UE data indicates that the transmitting UE equipment is an aerial UE (e.g., UE type=aerial). Generally, UE type data can provide indication of the type of UE that it is by using bit data, flag data, and the like. For instance, in some embodiments, a bit can be used to distinguish between aerial type UE and terrestrial based UE. In other embodiments, flag data can be employed to identify UE as being aerial based or terrestrial based. Additionally and/or alternatively, UE type data can be based, for instance, on international mobile subscriber identification (IMSI) data, subscriber identity module or subscriber identification module (SIM) data, and/or other similar data that can convey information regarding the type of UE that is in communication with core equipment 102. For instance, IMSI can comprise a first group of alphanumeric character values that can uniquely identify UE as being terrestrial based UE, and/or a second grouping of alphanumeric character values that can specifically identify UE as being aerial UE.

Core equipment 102 in response to identifying that the UE is an aerial UE can determine that the value to be associated with a drx inactivity timer for an aerial UE should typically be longer than a drx inactivity timer generally associated with a terrestrial based UE, and as such core equipment 102 can ensure that the drx inactivity timer values to be associated with the aerial UE should be greater than values typically associated with a T311 timer typically associated with terrestrial based UE. By associating drx inactivity timer values that are greater than typical T311 timer values associated with terrestrial based UE, core equipment 102 implicitly recognizes that aerial UE can be unreachable during a period denoted as:

Δ=drx-inactivity timer.expire−T311.expire

Core equipment 102 can thereafter initiate a drx inactivity timer with time values that exceed time values associated with T311 time values.

Core equipment 102, as is typical of core equipment, on receipt of DL.data addressed to UE (and in particular aerial UE 104) can forward the DL.data to the UE (e.g., aerial UE 104). When core equipment 102 transmits the DL.data to aerial UE 104, core equipment 102 can constantly monitor the DL.data to determine whether or not the DL.data has been received by aerial UE 104 (e.g., core equipment 102 expects aerial UE 104, within a defined period of time, denoted as γ, to respond to the dispatch of the DL.data with corresponding acknowledgement (ACK) data). Failure by aerial UE 104 to respond with corresponding ACK data within the defined period of time γ can cause core equipment 102 to conclude that aerial UE 104 is unreachable by core equipment, and in response to concluding that aerial UE 104 is unreachable, core equipment can request groups of more proximate core equipment, such as proximate base station equipment, proximate eNodeB equipment, proximate IoT equipment, proximate gNodeB equipment, proximate serving cell equipment, proximate evolved packet core equipment, proximate access point equipment, and the like to immediately release the radio bearer established to link the unreachable aerial UE (e.g., aerial UE 104) and core equipment 102.

The groups of more proximate core equipment, by releasing the radio bearer linking aerial UE 104 to core equipment 102 (and more particularly to the more proximate core equipment) can determine that aerial UE 104 has experienced a RLF event and accordingly that aerial UE 104 has transitioned from a connected state (e.g., RRC connected) to an idle state (e.g., RRC idle). Nevertheless, despite the fact that the aerial UE 104 has been deemed to have experienced an RLF event and it is assumed that aerial UE 104 has entered into an idle state, DL.data addressed to the aerial UE 104 can still be received by core equipment 102. This DL.data can be persisted to one or more buffers (e.g., one or more memories) associated with core equipment 102 to await future delivery to aerial UE 104. Contemporaneously, or in near contemporaneity, with persisting DL.data addressed to aerial UE 104 to buffer, core equipment 102 can send paging message data to aerial UE 104. The paging message data can comprise wake up data that can facilitate locating of aerial UE 104 and well as facilitate aerial UE 104 to transition from an idle state (e.g., RRC idle) to a connected state (e.g., RRC connect), and once having entered the connected state to re-establish connection with core equipment 102. At the same time as sending paging message data to aerial UE 104, or shortly thereafter (e.g., once aerial UE 104 has re-established connection with core equipment 102), core equipment 102 can send the buffered DL.data addressed to aerial UE 104 to aerial UE 104.

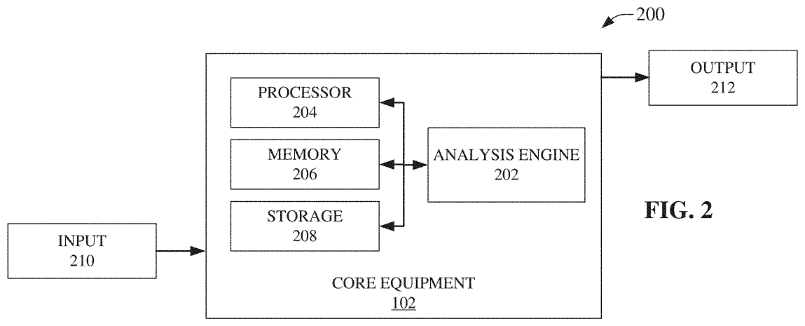

With reference to FIG. 2 that illustrates a system 200, in accordance with various embodiments, reduces or eliminates situations in which aerial UE become unreachable by core MNO equipment as a consequence of RLF events. System 200 provides further detail in regard to core equipment 102 and can comprise analysis engine 202 that can be communicatively coupled to processor 204, memory 206, and storage 208. Analysis engine 202 can be in communication with processor 204 for facilitating operation of computer and/or machine executable instructions and/or components by analysis engine 202, memory 206 for storing data and/or the computer or machine executable instructions and/or components, and storage 208 for providing longer term storage for data and/or machine and/or computer machining instructions. Additionally, system 200 can receive input 210 for use, manipulation, and/or transformation by analysis engine 202 to produce one or more useful, concrete, and tangible result, and/or transform one or more articles to different states or things. Further, system 200 can also generate and output the useful, concrete, and tangible results, and/or the transformed one or more articles produced by analysis engine 202, as output 212.

In some embodiments, system 200 can be Internet of Things (IoT) small form factor equipment capable of effective and/or operative communication with a network topology. Additionally in alternative embodiments, system 200 can be any type of mechanism, machine, device, apparatus, equipment, and/or instrument that can be utilized to dynamically configure inter-cell interference coordination between terrestrial based serving cell equipment that are serving aerial UE. Examples of types of mechanisms, equipment, machines, devices, apparatuses, and/instruments can include virtual reality (VR) devices, wearable devices, heads up display (HUD) devices, machine type communication devices, and/or wireless devices that communicate with radio network nodes in a cellular or mobile communication system. In various other embodiments, system 100 can comprise tablet computing devices, handheld devices, server class computing machines and/or databases, laptop computers, notebook computers, desktop computers, cell phones, smart phones, commercial and/or consumer appliances and/or instrumentation, industrial devices and/or components, personal digital assistants, multimedia Internet enabled phones, Internet enabled devices, multimedia players, aeronautical/avionic devices associated with, for example, orbiting satellites and/or associated aeronautical vehicles, and the like.

As noted above, system 200 (e.g., core equipment 102) can be central node global control equipment located on a MNO core network infrastructure. Examples of central node global control devices can comprise mobile edge compute (MEC) equipment, self organized network (SON) equipment, radio access network (RAN) intelligent controller (RIC) equipment, and/or similar equipment that can perform the functionalities and/or facilities described and/or disclosed herein.

Analysis engine 202 can receive UE data comprising UE type data from UE equipment. In response to receiving UE data analysis engine 202 can determine whether the UE data indicates that the transmitting UE equipment is an aerial UE (e.g., UE type=aerial). UE type data can supply indication of the type of UE that it is by using bit data, flag data, and the like. In certain embodiments UE type data can comprise bit data that can be used to distinguish between aerial type UE and terrestrial based UE. In other embodiments, flag data can be employed to identify UE as being aerial based or terrestrial based. Additionally and/or alternatively, UE type data can be based, for instance, on international mobile subscriber identification (IMSI) data, subscriber identity module or subscriber identification module (SIM) data, and/or other similar data that can convey information regarding the type of UE that is in communication with core equipment 102. In some instances, IMSI can comprise a first group of alphanumeric character values that can uniquely identify UE as being terrestrial based UE, and/or a second grouping of alphanumeric character values that can specifically identify UE as being aerial UE. In some instances, the first group of alphanumeric character values and/or the second grouping of alphanumeric character values can be established by international agreement (e.g., through a technical standards organization). In other instances, the first group of alphanumeric character values and/or the second grouping of alphanumeric character values can be determined and used within an identified MNO infrastructure or a grouping of disparate MNO infrastructures.

Analysis engine 202, in response to identifying that the UE is an aerial UE can further determine that the value associated with a drx inactivity timer associated with the aerial UE should be longer than a T311 timer generally associated with a terrestrial based UE, and as such analysis engine 202 can ensure that the drx inactivity timer values to be conveyed to the aerial UE are greater than values typically associated with a T311 timer associated with terrestrial based UE. By assigning drx inactivity timer values that are greater than typical T311 timer values associated with terrestrial based UE, analysis engine 202 is recognizing that aerial UE can be unreachable during a period denoted as:

Δ=drx-inactivity timer.expire−T311.expire

Analysis engine 202 can thereafter initiate, for aerial UE, a drx inactivity timer with time values that exceed time values associated with T311 time values generally associated with terrestrial based UE.

Analysis engine 202 on receiving DL.data addressed to aerial UE (e.g., aerial UE 104) can forward the DL.data to the aerial UE. When analysis engine 104 transmits the DL.data to aerial UE, analysis engine 202 can constantly monitor the DL.data to determine whether or not the DL.data has been received by aerial UE (e.g., there is an expectation by analysis engine 202 that aerial UE, within a defined period of time, denoted as γ, will respond to the dispatch of the DL.data with corresponding acknowledgement (ACK) data). Failure by aerial UE to respond with corresponding ACK data within the defined period of time γ can cause analysis engine 202 to conclude that aerial UE is unreachable by core equipment, and in response to concluding that aerial UE is unreachable, analysis engine 202 can request groups of more proximate core equipment to immediately release the radio bearer established to link the now determined unreachable aerial UE (e.g., aerial UE 104) and the core equipment.

As noted earlier, the groups of more proximate core equipment, by releasing the radio bearer linking aerial UE to core equipment can infer that aerial UE has experienced a RLF event and accordingly that aerial UE has transitioned from a first state (e.g., RRC connected) to a second state (e.g., RRC idle). Nevertheless, despite the fact that the aerial UE has been deemed, by analysis engine 202, to have experienced an RLF event and it can be assumed that aerial UE has entered into a second state, DL.data addressed to the aerial UE can still be received by core equipment. This DL.data can therefore be persisted to one or more buffers (e.g., memory 206 and/or storage 208) associated with core equipment 102 to await future delivery to aerial UE. Contemporaneously, or in near contemporaneity, with facilitating and/or effectuating storage of DL.data addressed to aerial UE to storage equipment (e.g., memory 206 and/or storage 208), analysis engine 202 can facilitate and/or effectuate transmission of paging message data to aerial UE. The paging message data can comprise wake up data that can facilitate locating of aerial UE and well as facilitate aerial UE to transition from an idle state (e.g., RRC idle) to a connected state (e.g., RRC connect), and once having entered the connected state to re-establish connection with core equipment. At the same time as having paging message data sent to aerial UE, or shortly after aerial UE has re-established connection with core equipment, analysis engine 202 can ensure that buffered/stored DL.data addressed to aerial UE 104 is sent to aerial UE 104.

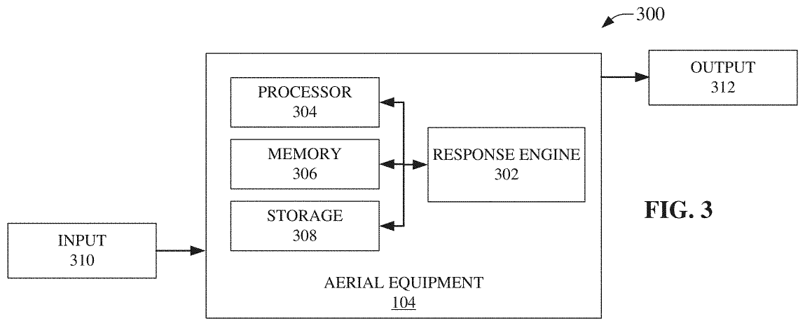

FIG. 3 depicts a system 300 that in accordance with embodiments reduces or eliminates situations in which aerial UE become unreachable by core MNO equipment as a consequence of RLF events. System 300 provides additional detail in regard to aerial UE 104. As illustrated, aerial UE 104 can comprise response engine 302 that can be communicatively coupled to processor 304, memory 306, and storage 308. Response engine 302 can be in communication with processor 304 for facilitating operation of computer and/or machine executable instructions and/or components by response engine 302, memory 306 for storing data and/or the computer or machine executable instructions and/or components, and storage 308 for providing longer term storage for data and/or machine and/or computer machining instructions. Additionally, system 300 can receive input 310 for use, manipulation, and/or transformation by response engine 302 to produce one or more useful, concrete, and tangible result, and/or transform one or more articles to different states or things. Further, system 300 can also generate and output the useful, concrete, and tangible results, and/or the transformed one or more articles produced by analysis engine 302, as output 312.

In some embodiments, system 300 can be Internet of Things (IoT) small form factor equipment capable of effective and/or operative communication with a network topology. Additionally in alternative embodiments, system 300 can be any type of mechanism, machine, device, apparatus, equipment, and/or instrument that can be utilized to dynamically configure inter-cell interference coordination between terrestrial based serving cell equipment that are serving aerial UE. Examples of types of mechanisms, equipment, machines, devices, apparatuses, and/instruments can include virtual reality (VR) devices, wearable devices, heads up display (HUD) devices, machine type communication devices, and/or wireless devices that communicate with radio network nodes in a cellular or mobile communication system. In various other embodiments, system 100 can comprise tablet computing devices, handheld devices, server class computing machines and/or databases, laptop computers, notebook computers, desktop computers, cell phones, smart phones, commercial and/or consumer appliances and/or instrumentation, industrial devices and/or components, personal digital assistants, multimedia Internet enabled phones, Internet enabled devices, multimedia players, aeronautical/avionic devices associated with, for example, orbiting satellites and/or associated aeronautical vehicles, and the like.

Response engine 302 in accordance with embodiments can send user equipment type data to core equipment. User equipment type data can comprise information representative of whether the UE equipment is an aerial UE (e.g., UE type=aerial). User equipment type data can provide indication of the type of UE that it is by using bit data, flag data, and the like. In certain embodiments user equipment type data can comprise one or more bit data that can be used to distinguish between aerial type UE and terrestrial based UE. In other embodiments, flag data can be employed to identify UE as being aerial based or terrestrial based. User equipment type data can be based, for instance, on international mobile subscriber identification (IMSI) data, subscriber identity module or subscriber identification module (SIM) data, and/or other similar data that can convey information regarding the type of UE that is in communication with core equipment. In some instances, IMSI can comprise groups of alphanumeric character values that can uniquely identify UE as being terrestrial based UE and/or groupings of alphanumeric character values that can specifically identify UE as being aerial UE. In some instances, the groups of alphanumeric character values and/or the groupings of alphanumeric character values can be established by consensual agreement between groups of MNOs.

As observed earlier, core equipment on receiving DL.data addressed to aerial UE can forward the DL.data to the aerial UE. When core equipment transmits the DL.data to aerial UE it can constantly monitor the DL.data to determine whether or not the DL.data has been received by aerial UE. Failure by aerial UE (e.g., response engine 302) to respond with corresponding ACK data within the defined period of time γ can cause core equipment to conclude that aerial UE is unreachable, and in response to concluding that aerial UE is unreachable, core equipment can request groups of more proximate core equipment to immediately release the radio bearer that has been established between the aerial UE and the core equipment.

By releasing the radio bearer providing communication links between aerial UE and core equipment, core equipment can determine that aerial UE has experienced a RLF event and accordingly that aerial UE has transitioned from a first state (e.g., RRC connected) to a second state (e.g., RRC idle). Nevertheless, despite the fact that the aerial UE has been deemed, by core equipment, to have experienced an RLF event DL.data addressed to the aerial UE can still be received by core equipment. This DL.data can therefore be persisted to one or more buffers associated with core equipment to await subsequent delivery to aerial UE 104.

As noted above, contemporaneously, or in near contemporaneity, with facilitating and/or effectuating storage of DL.data addressed to aerial UE to storage equipment, core equipment can also facilitate and/or effectuate transmission of paging message data to aerial UE. In response to receiving the paging messaging data from core equipment, response engine 302 can facilitate and/or effectuate processes to transition aerial UE 104 from an idle state (e.g., RRC idle) to a connected state (e.g., RRC connect), and once having entered the connected state, response engine 302, can facilitate and/or effectuate re-establishing connection links (e.g., a radio bearer)to core equipment. Once an radio bearer link has been re-established with core equipment, response engine 302 can facilitate and/or effectuate processes required to receive, from core equipment, any and all buffered DL.data addressed to aerial UE 104.

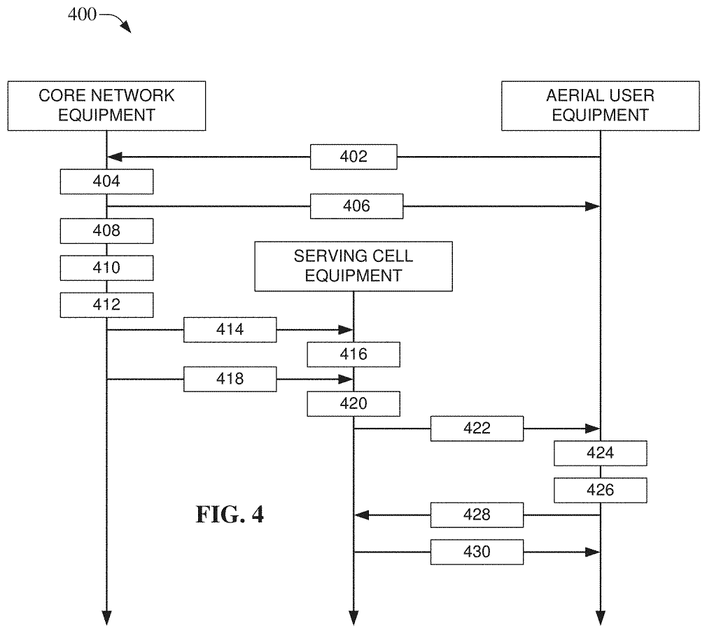

In view of the example system(s) described above, example method(s) that can be implemented in accordance with the disclosed subject matter can be better appreciated with reference to the flowcharts and/or illustrative time sequence charts in FIGS. 4-7. For purposes of simplicity of explanation, an example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example method disclosed throughout the subject specification are capable of being stored on an article of manufacture (e.g., a computer-readable medium) to allow transporting and transferring such methods to computers for execution, and thus implementation, by a processor or for storage in a memory.

FIG. 4 provides depiction of a time sequence chart or method 400 that can be utilized to reduce or eliminate situations in which aerial UE become unreachable by core MNO equipment as a consequence of RLF events. At act 402 UE can send, and core equipment can receive, UE data comprising UE type data. At act 404, in response to receiving UE data, core equipment can determine whether the UE data indicates that the transmitting UE equipment is an aerial UE (e.g., UE type=aerial). Generally, UE type data can provide indication of the type of UE that it is by using one or more bits of data, flag data, and the like.

Further, at act 404, core equipment, in response to identifying that the UE is an aerial UE, can determine that a value to be associated with a drx inactivity timer for the aerial UE should be longer than a T311 timer typically associated with a terrestrial based UE, and as such core equipment 102 can ensure that the drx inactivity timer values to be used in the context of the aerial UE should be greater than values typically associated with a T311 timer and used for terrestrial based UE. Also at act 404 core equipment can thereafter initiate a drx inactivity timer with time values that exceed time values associated with T311 time values used for terrestrial based UE.

Core equipment, as is typical of core equipment, on receipt of DL.data addressed to UE (and in particular aerial UE 104) can, at act 406, forward the DL.data to the UE. When core equipment transmits the DL.data to aerial UE, core equipment, at act 408, can constantly monitor the DL.data to determine whether or not the DL.data has been received by aerial UE (e.g., there is an expectation by core equipment that aerial UE, within a defined period of time, denoted as γ, to respond to the dispatch of the DL.data with corresponding ACK packet data). Failure by aerial UE to respond, at act 408, with corresponding ACK data within the defined period of time γ can cause core equipment, at act 410, to conclude, at act 412, that aerial UE is unreachable by core equipment, and in response to concluding that aerial UE is unreachable, core equipment can, at act 414, request groups of more proximate core equipment to immediately release the radio bearer established to link between the now unreachable aerial UE and core equipment.

The groups of more proximate core equipment, by releasing the radio bearer linking aerial UE 104 to core equipment 102 can, at act 416, determine that aerial UE has experienced a RLF event and accordingly that aerial UE 104 has transitioned from a connected state (e.g., RRC connected) to an idle state (e.g., RRC idle). Nevertheless, despite the fact that the aerial UE has now been deemed to have experienced an RLF event and it is assumed that aerial UE has entered into an idle state, DL.data addressed to the aerial UE can still, at act 418, be received by core equipment.

At act 420, the received DL.data can be persisted to one or more buffers (e.g., one or more memories) associated with core equipment to await subsequent delivery to aerial UE. At act 422, contemporaneously, or in near contemporaneity, with persisting DL.data addressed to aerial UE to buffer, core equipment can also send paging message data to aerial UE. The paging message data transmitted at act 422 can comprise wake up data that can facilitate locating of aerial UE as well as facilitate aerial UE, at act 424, to transition from an idle state (e.g., RRC idle) to a connected state (e.g., RRC connect), and once having entered the connected state, at act 426, reactivate processes that can have been placed in states of hibernation, and at act 428, to re-establish connection with core equipment. At the same time as sending paging message data to aerial UE, or shortly thereafter (e.g., once aerial UE has re-established connection, at act 428, with core equipment), core equipment can, at act 430, send the buffered DL.data addressed to aerial UE to aerial UE.

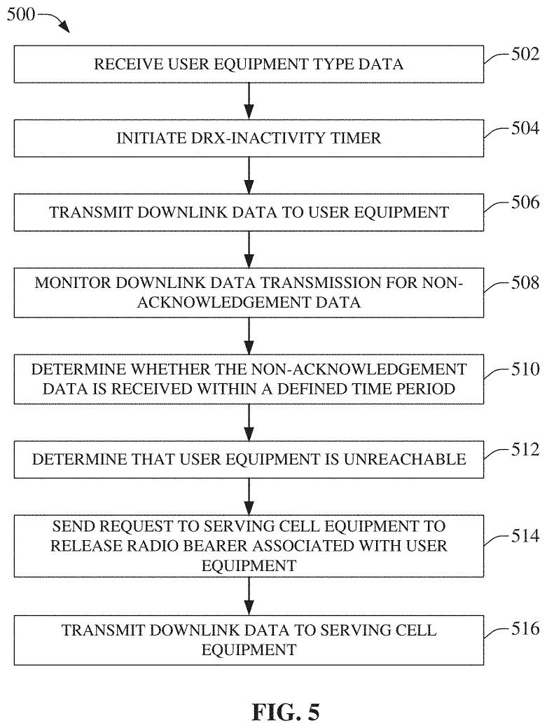

FIG. 5 a flow chart or method 500 for reducing or eliminating situations in which aerial user equipment become unreachable by core MNO equipment as a consequence of RLF events. Method 500 can commence at act 502 wherein core equipment can receive UE data comprising UE type data from UE equipment. Also at act 502, based at least on the received UE data, a determination can be undertaken to determine whether the UE data indicates that the transmitting UE equipment is an aerial UE.

At act 504, in response to identifying that the UE is an aerial UE, a determination can be made as to an appropriate time value to be associated with a drx inactivity timer associated in the context of the aerial UE, and thereafter the drx inactivity timer with time values that exceed time values typically associated with T311 time values generally associated with terrestrial based UE can be initiated.

At act 506, on receiving DL.data addressed to aerial UE this can be forwarded to the aerial UE. Further, in response to transmitting the DL.data to aerial UE, at act 508 the transmission of the DL.data can constantly be monitored to determine whether or not the DL.data has been received by aerial UE. Failure by aerial UE to respond with corresponding ACK data within the defined period of time γ, at act 510, can lead to the conclusion that aerial UE has become unreachable by core equipment, and in response to a determination that aerial UE has become unreachable, at act 512, a request to groups of more proximate core equipment (e.g., serving cell equipment in proximity to aerial UE) to immediately release the radio bearer established to link the now determined unreachable aerial UE (e.g., aerial UE 104) and the core equipment can be facilitated at act 514.

As noted earlier, while the aerial UE may have been deemed to be unreachable, DL.data addressed to the aerial UE can still be received by core equipment, and at act 516 can be forwarded on to core equipment that are located more proximate to aerial UE. Such more proximate core equipment can be groups of serving cell equipment, such as base station equipment.

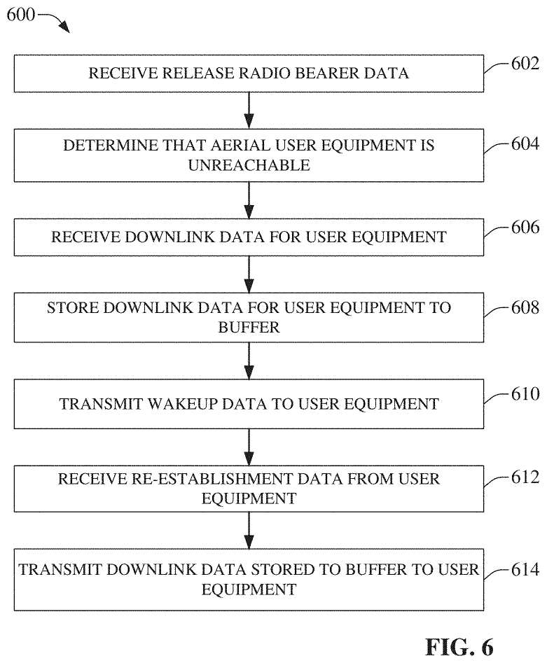

FIG. 6 illustrates another flow chart or method 600 for reducing or eliminating situations in which aerial user equipment become unreachable by core MNO equipment as a consequence of RLF events. Method 600 can begin at act 602 wherein core equipment, such as serving cell equipment, can receive release radio bearer data. In response to receiving the release radio bearer data, the serving cell equipment can release the radio bearer servicing aerial UE and can determine at act 604 that the aerial UE has become unreachable. At act 606, even after the serving cell equipment has released the radio bearer for the aerial UE, core equipment (e.g., other than serving cell equipment) generally can periodically receive DL.data addressed to aerial UE, this data can be forwarded to core equipment more proximate to aerial UE (e.g., serving cell equipment). At act 608 any DL.data received for aerial UE can temporarily be stored to one or more memory or storage equipment for subsequent delivery to aerial UE. At act 610, in response to receiving and/or storing DL.data addressed to aerial UE to temporary storage facilities, wakeup data can be transmitted to aerial UE. The wakeup data can facilitate aerial UE to transition from a first state (e.g., RRC idle) to a second state (e.g., RRC connect), reactivate one or more processes that can have been placed in states of hibernation when the aerial UE had earlier transitioned from a connected state to an idle state, and re-establish communication links with core equipment. At act 612, core equipment (e.g., serving cell equipment) can receive re-establishment data from aerial UE. Further, core equipment (e.g., serving cell equipment) can transmit DL.data that can have been temporary stored to one or more memory and/or storage equipment to aerial UE.

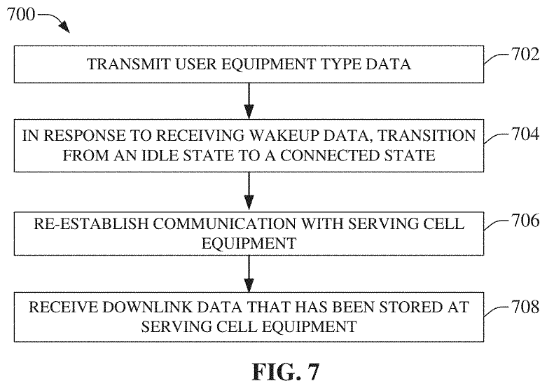

FIG. 7 another flow chart or method 700 for reducing or eliminating situations in which aerial user equipment become unreachable by core MNO equipment as a consequence of RLF events. Method 700 can commence at act 702 aerial UE can send user equipment type data to core equipment. User equipment type data can comprise information representative of whether the UE equipment is an aerial UE (e.g., UE type=aerial). User equipment type data can provide indication of the type of UE that it is by using bit sequence data, flag data, and the like. At 704 aerial UE in response to receiving the paging messaging data from core equipment, can facilitate and/or effectuate processes to transition aerial UE from an idle state (e.g., RRC idle) to a connected state (e.g., RRC connect), and once having entered the connected state, at act 706, can facilitate and/or effectuate re-establishing connection links (e.g., a radio bearer) to core equipment. Once an radio bearer link has been re-established with core equipment, aerial UE at act 708 can facilitate and/or effectuate processes required to receive, from core equipment, DL.data that is addressed to aerial UE.

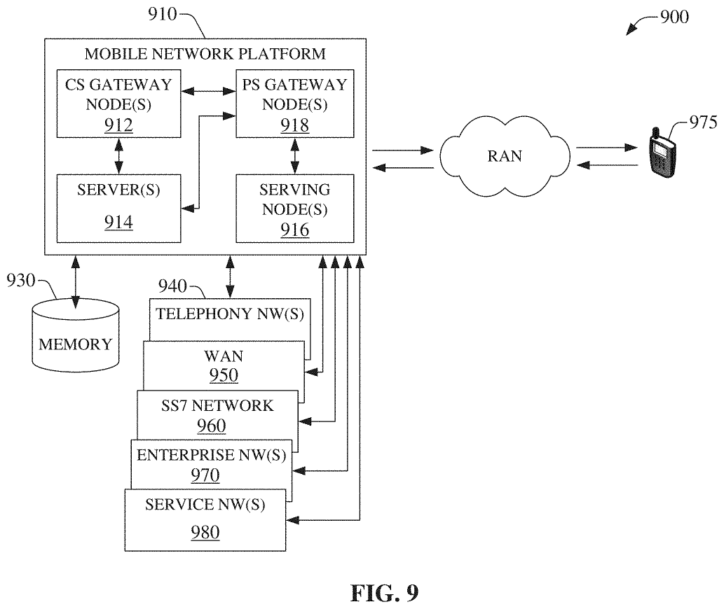

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 960; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 970 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 970, or SS7 network 960. In an aspect, memory 930 can be, for example, accessed as part of a data store component or as a remotely connected memory store.

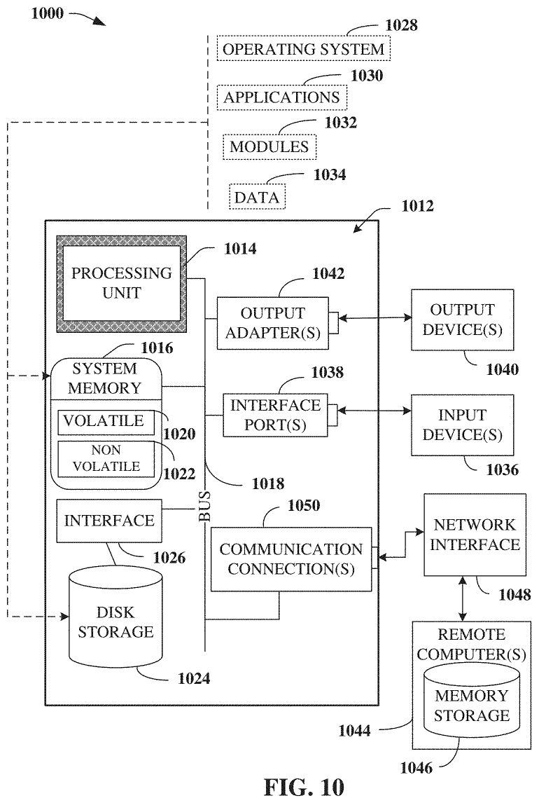

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute one or more parts of one or more of the disclosed example embodiments. Computer 1012, which can be, for example, part of the hardware of system 100, includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect, Card Bus, Universal Serial Bus (USB), Advanced Graphics Port (AGP), Personal Computer Memory Card International Association bus (PCMCIA), Firewire (IEEE 1094), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile device and/or portable device can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) LTE; 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of embodiments illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. Network equipment, comprising:
a processor; and
a memory that stores instructions that, when executed by the processor, facilitates performance of operations, comprising:
receiving, from a user equipment, type data;
determining, based on the type data, that the user equipment is an aerial user equipment;
determining first defined time values associated with a discontinuous reception timer and second defined time values associated with a radio link failure timer;
transmitting downlink data addressed to the aerial user equipment;
based on an expiration of one of the first defined time values or the second time values and acknowledgement data associated with the transmitting of the downlink data, determining that the aerial user equipment is unreachable; and
based on the aerial user equipment being unreachable, sending request data to serving equipment, wherein the request data facilitates the serving equipment to release a radio bearer that communicatively links the network equipment to the aerial user equipment.

2. The network equipment of claim 1, wherein the type data is bit data representing a sequence of bits.

3. The network equipment of claim 1, wherein the type data represents international mobile subscriber identification data.

4. The network equipment of claim 1, wherein the first defined time values are greater than the second defined time values, and wherein the second defined time values are associated with terrestrial based user equipment.

5. The network equipment of claim 1, wherein the expiration is a first expiration, wherein the first defined time values are greater than the second defined time values, and wherein in response to the aerial user equipment experiencing a radio link failure and reestablishing connection with the network equipment after a second expiration of the second defined time values, the aerial user equipment is unreachable until the first expiration of the first defined time values.

6. The network equipment of claim 1, wherein the operations further comprise, in response to transmitting the downlink data, monitoring the transmitting of the downlink data to the aerial user equipment.

7. A method, comprising:
receiving, by serving equipment comprising a processor, release radio bearer data from network equipment;
based on the release radio bearer data, terminating, by the serving equipment, a communications link established between the serving equipment and an aerial user equipment;
based on the release radio bearer data, determining, by the serving equipment, that the aerial user equipment has transitioned from a first state to a second state;
receiving, by the serving equipment, downlink data addressed to the aerial user equipment; and
based on receiving the downlink data, transmitting, by the serving equipment, wake up data to the aerial user equipment.

8. The method of claim 7, wherein the wake up data facilitates the aerial user equipment to re-establish the communications link to the serving equipment.

9. The method of claim 7, further comprising, in response to determining that the aerial user equipment has entered the second state, storing, by the serving equipment, the downlink data addressed to the aerial user equipment.

10. The method of claim 7, wherein the first state is a connected state.

11. The method of claim 7, wherein the second state is an idle state.

12. The method of claim 7, wherein the wake up data facilitates the aerial user equipment to transition from the second state to the first state.

13. The method of claim 12, further comprising, based on the aerial user equipment being in the first state, transmitting, by the serving equipment, the downlink data addressed to the aerial user equipment.

14. A non-transitory machine-readable medium, comprising executable instructions that, when executed by a processor, facilitate performance of operations, comprising:
determining, based on type data, that a user equipment is an aerial user equipment;
determining first defined time values associated with a discontinuous reception timer and second defined time values associated with a radio link failure indicator timer;
transmitting downlink data addressed to the aerial user equipment;
based on the first defined time values being greater than the second defined time values and acknowledgement data associated with the transmitting of the downlink data, determining that the aerial user equipment is unreachable; and
based on the aerial user equipment being unreachable, sending request data to base station equipment, wherein the request data facilitates the base station equipment to terminate a communication channel that links the base station equipment to the aerial user equipment.

15. The non-transitory machine-readable medium of claim 14, wherein the operations further comprise receiving the type data from the aerial user equipment.

16. The non-transitory machine-readable medium of claim 14, wherein the second defined time values are associated with terrestrial based user equipment.

17. The non-transitory machine-readable medium of claim 14, wherein the operations further comprise, in response to transmitting the downlink data, monitoring the transmitting of the downlink data to the aerial user equipment.

18. The non-transitory machine-readable medium of claim 17, wherein the operations further comprise determining, based on the transmitting of the downlink data, that the aerial user equipment has failed to return the acknowledgement data.

19. The non-transitory machine-readable medium of claim 14, wherein the operations further comprise in response to determining that the aerial user equipment is unreachable, determining that the aerial user equipment has transitioned from a connected state to an idle state.

20. The non-transitory machine-readable medium of claim 14, wherein the operations further comprise in response to determining that the user equipment is unreachable, storing the downlink data to a storage device.
